(19) United States
(12) Patent Application Publication
(10) Pub. No.: US 2006/0076876 A1
(43) Pub. Date: Apr. 13, 2006

(54) Plasma display panel and plasma display apparatus comprising electrode

(75) Inventor: Woo Tae Kim, Yongin-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/246,120

(22) Filed: Oct. 11, 2005

(30) Foreign Application Priority Data
Oct. 11, 2004 (KR) 10-2004-0081129

(51) Int. Cl. H01J 1/62

(52) U.S. Cl. 313/483

(57) ABSTRACT

The present invention relates to a plasma display panel and a plasma display apparatus, and more particularly, to a plasma display panel and plasma display apparatus comprising electrodes. In the plasma display panel and the plasma display apparatus of the present invention, electrodes are formed on upper and lower sides of a discharge cell, respectively, to form a first discharge gap and a second discharge gap. In accordance with the present invention, since a plurality of discharge gaps is formed, the discharge amount can be increased and discharge diffusion can be facilitated. In addition, a discharge sustain voltage can be lowered and brightness and discharge efficiency can be enhanced.

### CROSS-REFERENCES TO RELATED APPLICATIONS

This Nonprovisional application claims priority under 35 U.S.C. § 119(a) on Patent Application No. 2004-81129 filed in Korea on Oct. 11, 2004 the entire contents of which are hereby incorporated by reference.

### BACKGROUND OF THE INVENTION

1. Field of the Invention

The present invention relates to a plasma display panel and a plasma display apparatus, and more particularly, to a plasma display panel and plasma display apparatus comprising electrodes.

2. Background of the Related Art

In general, a plasma display panel comprises a front substrate and a rear substrate comprised of soda-lime glass. Barrier ribs formed between the front substrate and the rear substrate partition discharge cells. An inert gas injected into the discharge cells, such as helium-xeon (He—Xe) or helium-neon (He—Ne), generates a discharge with a high frequency voltage. When the discharge is generated, an inert gas generates vacuum ultraviolet rays. Vacuum ultraviolet rays excite phosphors formed between the barrier ribs, thus displaying images.

FIG. 1 is a perspective view schematically showing the construction of a conventional plasma display panel. As shown in FIG. 1, the conventional plasma display panel comprises a front panel and a rear panel. The front panel comprises a front glass substrate 10. The rear panel comprises a rear glass substrate 20. The front panel and the rear panel are parallel to each other with a predetermined gap therebetween.

On the front glass substrate 10 is formed a sustain electrode pair 11 and 12 for sustaining the emission of a cell through a mutual discharge. The sustain electrode pair comprises the scan electrodes 11 and the sustain electrodes 12. The scan electrode 11 comprises a transparent electrode 11a formed of a transparent ITO material and a bus electrode 11b formed of a metal material. The sustain electrode 12 comprises a transparent electrode 12a formed of a transparent ITO material and a bus electrode 12b formed of a metal material. The scan electrode 11 receives a scan signal for scanning a panel and a sustain signal for sustaining a discharge. The sustain electrode 12 mainly receives a sustain signal. A dielectric layer 13a is formed on the sustain electrode pair 11 and 12, and functions to limit the discharge current and provide insulation between the electrode pairs. A protection layer 14 is formed of magnesium oxide (MgO) on a top surface of the dielectric layer 13a so as to facilitate a discharge.

Address electrodes 22 intersecting the sustain electrode pair 11 and 12 are disposed on the rear glass substrate 20. A dielectric layer 13b formed on the address electrodes 22 functions to provide insulation between the address electrodes 22. Barrier ribs 21 formed on the dielectric layer 13b partition discharge cells. R, G and B phosphor layer 23 coated between the barrier ribs 21 and the barrier ribs 21 radiate a visible ray for displaying images.

The front glass substrate 10 and the rear glass substrate 20 are combined together by a sealing material. An inert gas, such as helium (He), neon (Ne) or xeon (Xe), is injected into the plasma display panel on which an exhaust process has been performed.

The conventional plasma display panel is subject to increased manufacturing cost given that such panel comprises expensive transparent electrodes. To solve this problem, a fence type electrode structure to be used instead of the transparent electrodes has been proposed.

FIG. 2 is a plan view of a discharge cell having the fence type electrode structure of the conventional plasma display panel.

As shown in FIG. 2, a plurality of scan bus electrodes 210 and a plurality of sustain bus electrodes 220 are formed on upper and lower sides of the panel within a discharge space without expensive transparent electrodes. In addition, a scan connection electrode 230 connecting the plurality of scan bus electrodes 210 and a sustain connection electrode 240 connecting the plurality of sustain bus electrodes 220 are formed in the plasma display panel.

The scan bus electrodes 210 connected by the scan connection electrode 230 and the sustain bus electrodes 210 connected by the sustain connection electrode 240 are separated from each other with a predetermined gap therebetween, and thus form a discharge gap 250.

In such a fence type electrode structure, a discharge can be generated without expensive transparent electrodes. Since a discharge is performed through opaque bus electrodes, however, the aperture ratio is reduced. Furthermore, since these opaque bus electrodes are all formed within the discharge space, the aperture ratio is reduced even further. The area in which the discharge space and the fence type bus electrodes overlap with each other is less than the area in which the discharge space and the transparent electrodes 11a and 12a of FIG. 1 overlap with each other. As a result, problems arise that the discharge amount is small and a discharge does not diffuse into the entire discharge space.

The problems of the low aperture ratio and poor discharge diffusion in the conventional fence type electrode structure result in an increased discharge sustain voltage of the plasma display panel and decreased brightness and discharge efficiency.

### SUMMARY OF THE INVENTION

Accordingly, the present invention has been made in view of the above problems, and it is an object of the present invention to provide a plasma display panel and a plasma display apparatus in which discharge diffusion can be facilitated only with bus electrodes.

Another object of the present invention is to provide a plasma display panel and a plasma display apparatus in which a discharge sustain voltage can be decreased and brightness and discharge efficiency can be increased.

A plasma display panel according to the present invention comprises a discharge cell partitioned by barrier ribs, an upper electrode part comprising a plurality of upper main electrodes and an upper connection electrode part that connects each of the plurality of upper main electrodes, and formed on an upper region of the discharge cell, a lower electrode part comprising a plurality of lower main electrodes and a lower connection electrode part that connects each of the plurality of lower main electrodes, and formed on a lower region of the discharge cell, a first center electrode part comprising a plurality of first center main electrodes and a first center connection electrode part that connects each of the plurality of first center main electrodes, and formed between the upper electrode part and the lower electrode part and a second center electrode part comprising a plurality of second center main electrodes and a second center connection electrode part that connects each of the plurality of second center main electrodes, and formed between the first center electrode part and the lower electrode part.

The upper electrode part and the lower electrode part function as a scan electrode and the first center electrode part and the second center electrode part function as a sustain electrode, and the upper electrode part and the lower electrode part function as the sustain electrode and the first center electrode part and the second center electrode part function as the scan electrode.

The upper electrode part and the first center electrode part form a first discharge gap.

The lower electrode part and the second center electrode part form a second discharge gap.

The first center electrode part and the second center electrode part are separated from each other.

A gap between the first center electrode part and the second center electrode part is equal to or greater than 50 μm to less than or equal to 200 μm.

At least one of the upper connection electrode part, the lower connection electrode part, the first center connection electrode part and the second center connection electrode part comprises one or more connection electrodes.

The width of at least one of the upper main electrode, the lower main electrode, the first center main electrode and the second center main electrode is equal to or greater than 30 μm to less than or equal to 60 μm.

A plasma display apparatus according to the present invention comprises a discharge cell partitioned by barrier ribs, an upper electrode part comprising a plurality of upper main electrodes and an upper connection electrode part that connects each of the plurality of upper main electrodes, and formed on an upper region of the discharge cell, a lower electrode part comprising a plurality of lower main electrodes and a lower connection electrode part that connects each of the plurality of lower main electrodes, and formed on a lower region of the discharge cell, a first center electrode part comprising a plurality of first center main electrodes and a first center connection electrode part that connects each of the plurality of first center main electrodes, and formed between the upper electrode part and the lower electrode part, a second center electrode part comprising a plurality of second center main electrodes and a second center connection electrode part that connects each of the plurality of second center main electrodes, and formed between the first center electrode part and the lower electrode part, a first driver that applies first driving pulses to the upper electrode part and the lower electrode part and a second driver that applies second driving pulses to the first center electrode part and the second center electrode part.

The first driver applies the first driving pulses to the upper electrode part and the lower electrode part so that the upper electrode part and the lower electrode part function as a scan electrode, and the second driver applies the second driving pulses to the first center electrode part and the second center electrode part so that the first center electrode part and the second center electrode part function as a sustain electrode.

The first driver applies the first driving pulses to the upper electrode part and the lower electrode part so that the upper electrode part and the lower electrode part function as a sustain electrode, and the second driver applies the second driving pulses to the first center electrode part and the second center electrode part so that the first center electrode part and the second center electrode part function as a acan electrode.

The first center electrode part and the second center electrode part are separated from each other.

A gap between the first center electrode part and the second center electrode part is equal to or greater than 50 μm to less than or equal to 200 μm.

### BRIEF DESCRIPTION OF THE DRAWINGS

Further objects and advantages of the invention can be more fully understood from the following detailed description taken in conjunction with the accompanying drawings in which:

FIG. 1 is a perspective view schematically showing the construction of a conventional plasma display panel;

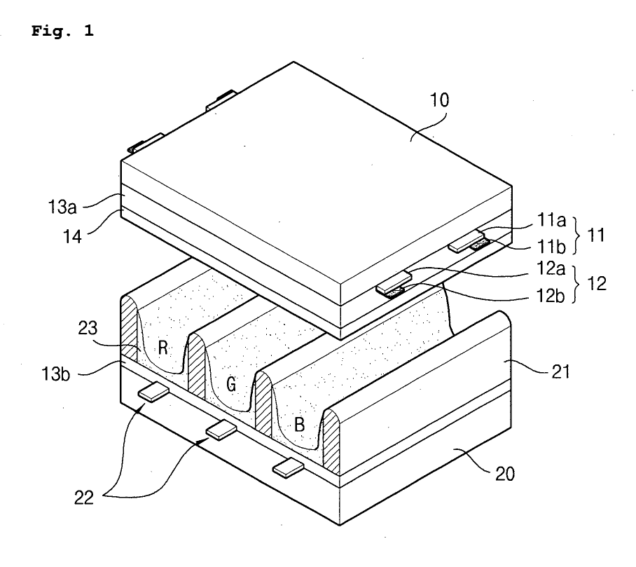

FIG. 2 is a plan view of a discharge cell having the fence type electrode structure of the conventional plasma display panel;

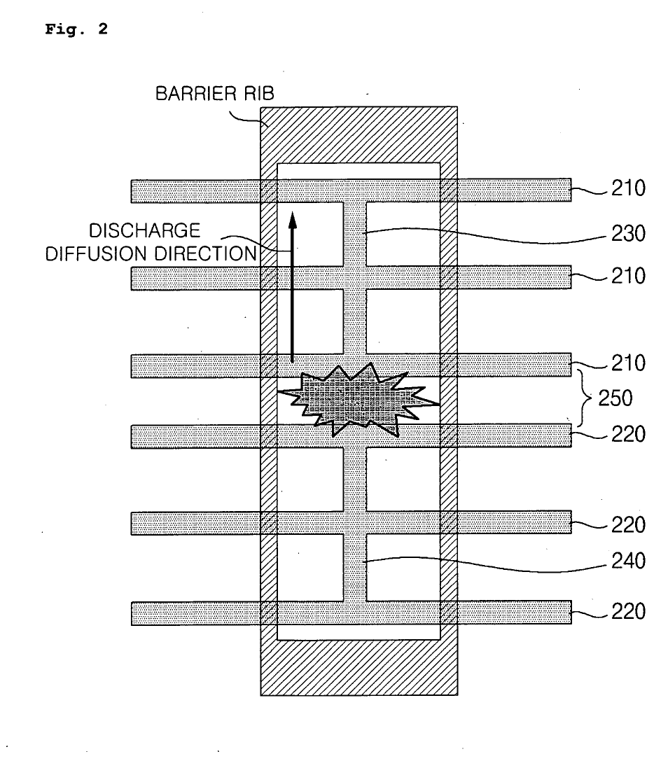

FIG. 3 is a plan view of a plasma display panel according to the present invention; and

FIG. 4 shows the construction of a plasma display apparatus according to the present invention.

### DETAILED DESCRIPTION OF THE PREFERRED EMBODIMENT

The present invention will now be described in detail in connection with preferred embodiments with reference to the accompanying drawings.

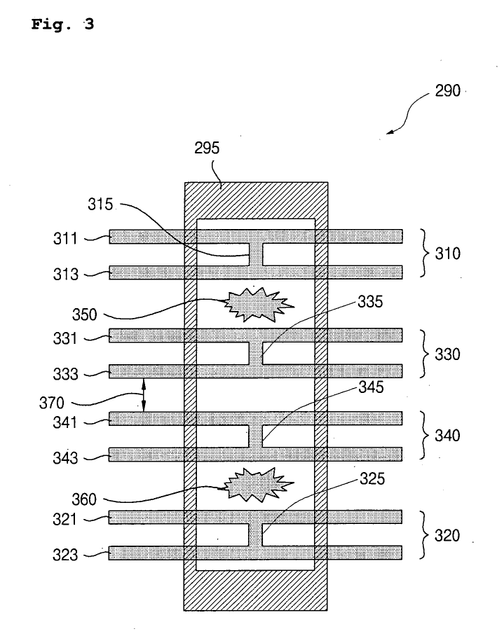

FIG. 3 is a plan view of a plasma display panel according to the present invention.

As shown in FIG. 3, the plasma display panel according to the present invention comprises a discharge cell 290, an upper electrode part 310, a lower electrode part 320, a first center electrode part 330 and a second center electrode part 340.

The discharge cell 290 is partitioned by a barrier rib 295. The upper electrode part 310 comprises a plurality of upper main electrodes 311 and 313 and an upper connection electrode part 315 that connects each of the plurality of upper main electrodes 311 and 313. The upper electrode part 310 is formed on an upper region of the discharge cell 290. As shown in FIG. 3, the upper connection electrode part 315 comprises one upper connection electrode. However, the upper connection electrode part 315 can comprise a plurality of upper connection electrodes. The plurality of upper main electrodes 311,313 and the upper connection electrode part 315 are bus electrodes. The width of each of the upper main electrodes 311,313 is equal to or greater than 30 μm to less than or equal to 60 μm.

The lower electrode part 320 comprises a plurality of lower main electrodes 321 and 323 and a lower connection electrode part 325 that connects each of the plurality of lower main electrodes 321 and 323. The lower electrode part 320 is formed on a lower region of the discharge cell 290. As shown in FIG. 3 that the lower connection electrode part 325 comprises one lower connection electrode. However, the lower connection electrode part 325 can comprise a plurality of lower connection electrodes. The plurality of lower main electrodes 321 and 323 and the lower connection electrode part 325 are bus electrodes. The width of each of the lower main electrodes 321 and 323 is equal to or greater than 30 μm to less than or equal to 60 μm.

The first center electrode part 330 comprises a plurality of first center main electrodes 331 and 333 and a first center connection electrode part 335 that connects each of the plurality of first center main electrodes 331 and 333, and is formed between the upper electrode part 310 and the lower electrode part 320. As shown in FIG. 3, the first center connection electrode part 335 comprises one first center connection electrode. However, the first center connection electrode part 335 can comprise a plurality of first center connection electrodes. The plurality of first center main electrodes 331 and 333 and the first center connection electrode part 335 are bus electrodes. The width of each of the first center main electrodes 331 and 333 is equal to or greater than 30 μm to less than or equal to 0 μm.

The second center electrode part 340 comprises a plurality of second center main electrodes 341 and 343 and a second center connection electrode part 345 that connects each of the plurality of second center main electrodes 341 and 343. The second center electrode part 340 is formed between the first center electrode part 330 and the lower electrode part 320. As shown in FIG. 3, the second center connection electrode part 345 comprises a second center connection electrode. However, the second center connection electrode part 345 can comprise a plurality of second center connection electrodes. The plurality of second center main electrodes 341 and 343 and the second center connection electrode part 345 are bus electrodes. The width of each of the second center main electrodes 341 and 343 is equal to or greater than 30 μm to less than or equal to 60 μm.

When the upper electrode part and the lower electrode part function as a scan electrode, the first center electrode part and the second center electrode part function as a sustain electrode. When the upper electrode part and the lower electrode part function as the sustain electrode, the first center electrode part and the second center electrode part function as the scan electrode.

Therefore, two discharge gaps 350 and 360 are formed within the discharge cell 290. That is, the upper electrode part 310 and the first center electrode part 330 form the first discharge gap 350, and the lower electrode part 320 and the second center electrode part 340 form the second discharge gap 360. In the plasma display panel constructed above according to the present invention, the plurality of discharge gaps 350 and 360 are formed in one discharge cell 290, thus increasing the discharge amount.

In addition, the connection electrode parts 315,325,335 and 345 and the main electrodes 311,313,321,323,331,333,341 and 343, which are comprised in the electrode parts 310,320,330 and 340, function to diffuse a discharge generated in the two discharge gaps 350 and 360 into the entire region of the discharge cell 290. Therefore, the plasma display panel of the present invention increases the discharge amount and facilitates discharge diffusion, so that discharge efficiency will be increased. Accordingly, the plasma display panel of the present invention can decrease a discharge sustain voltage and can increase brightness and discharge efficiency. In addition, since the plurality of discharge gaps 350 and 360 are formed on the upper and lower sides of the discharge cell 290, respectively, a sufficient amount of wall charges can be accumulated on each electrode.

Preferably, the first center electrode part 330 and the second center electrode part 340 of the present invention can be separated from each other. A gap 370 between the first center electrode part 330 and the second center electrode part 340 can range from is equal to or greater than 50 μm to less than or equal to 200 μm.

In the case where the first center electrode part 330 and the second center electrode part 340 are not separated from each other, a discharge generated in the first discharge gap 350 has an effect on a discharge generated in the second discharge gap 360. That is, although the two discharge gaps 350 and 360 have the same design value, a discharge that is first generated by the distribution of wall charges influences subsequently generated discharge.

For example, if a discharge is generated in the first discharge gap 350 formed by the upper electrode part 310 and the first center electrode part 330 with the first center electrode part 330 and the second center electrode part 340 being connected to each other, wall charges on the first center electrode part 330 move toward the second center electrode part 340, and have an effect on a discharge that is generated in the second discharge gap 360 formed by the second center electrode part 340 and the lower electrode part 320. For this reason, preferably the first center electrode part 330 and the second center electrode part 340 are separated from each other, as shown in FIG. 3.

The plasma display apparatus according to the present invention will be described in detail with reference to the accompanying drawing.

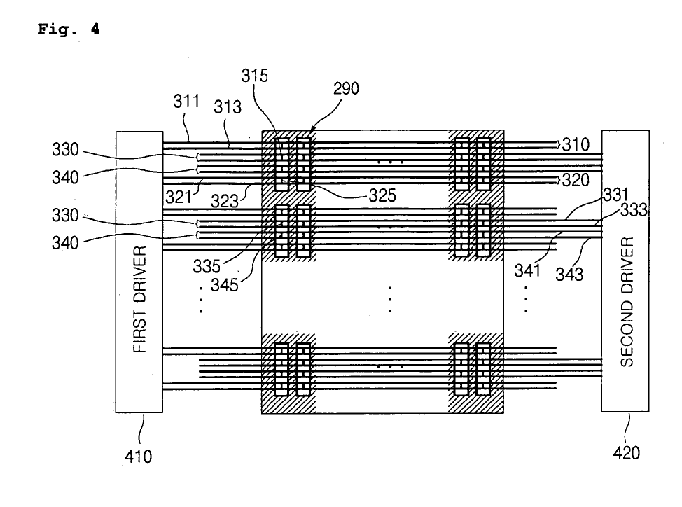

FIG. 4 shows the construction of a plasma display apparatus according to the present invention.

As shown in FIG. 4, the plasma display apparatus according to the present invention comprises a discharge cell 290, an upper electrode part 310, a lower electrode part 320, a first center electrode part 330, a second center electrode part 340, a first driver 410 and a second driver 420. The discharge cell 290, the upper electrode part 310, the lower electrode part 320, the first center electrode part 330 and the second center electrode part 340 according to the present invention have the same construction as that described above. Detailed description thereof will be omitted.

The first driver 410 applies first driving pulses to the upper electrode part 310 and the lower electrode part 320.

The second driver 420 applies second driving pulses to the first center electrode part 330 and the second center electrode part 340.

If the first driver 410 applies the first driving pulses, such as a reset pulse, a scan pulse and a sustain pulse, to the upper electrode part 310 and the lower electrode part 320, the upper electrode part 310 and the lower electrode part 320 function as a scan electrode. The second driver 420 applies the second driving pulses to the first center electrode part 330 and the second center electrode part 340 so that the first center electrode part 330 and the second center electrode part 340 function as the sustain electrodes.

To the contrary, if the second driver 420 applies the first driving pulses, such as a reset pulse, a scan pulse and a sustain pulse, to the first center electrode part 330 and the second center electrode part 340, the first center electrode part 330 and the second center electrode part 340 serve as scan electrodes. The second driver 420 applies the second driving pulses to the upper electrode part 310 and the lower electrode part 320 so that the upper electrode part 310 and the lower electrode part 320 serve as the sustain electrodes.

Preferably, the first center electrode part 330 and the second center electrode part 340 of the present invention are separated from each other. Preferably, the gap 370 between the first center electrode part 330 and the second center electrode part 340 is equal to or greater than 50 μm to less than or equal to 200 μm.

As described above, in accordance with the present invention, since a plurality of discharge gaps are formed, the discharge amount will increase and discharge diffusion will be facilitated.

Since a plurality of discharge gaps are formed, a discharge sustain voltage will decrease and brightness and discharge efficiency will be improved.

The invention being thus described may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display panel, comprising:
a discharge cell partitioned by barrier ribs;
an upper electrode part comprising a plurality of upper main electrodes and an upper connection electrode part that connects each of the plurality of upper main electrodes, and formed on an upper region of the discharge cell;
a lower electrode part comprising a plurality of lower main electrodes and a lower connection electrode part that connects each of the plurality of lower main electrodes, and formed on a lower region of the discharge cell;
a first center electrode part comprising a plurality of first center main electrodes and a first center connection electrode part that connects each of the plurality of first center main electrodes, and formed between the upper electrode part and the lower electrode part; and
a second center electrode part comprising a plurality of second center main electrodes and a second center connection electrode part that connects each of the plurality of second center main electrodes, and formed between the first center electrode part and the lower electrode part.

2. The plasma display panel as claimed in claim 1, wherein the upper electrode part and the lower electrode part function as a scan electrode and the first center electrode part and the second center electrode part function as a sustain electrode, and
Wherein the upper electrode part and the lower electrode part function as the sustain electrode and the first center electrode part and the second center electrode part function as the scan electrode.

3. The plasma display panel as claimed in claim 1, wherein the upper electrode part and the first center electrode part form a first discharge gap.

4. The plasma display panel as claimed in claim 1, wherein the lower electrode part and the second center electrode part form a second discharge gap.

5. The plasma display panel as claimed in claim 1, wherein the first center electrode part and the second center electrode part are separated from each other.

6. The plasma display panel as claimed in claim 5, wherein a gap between the first center electrode part and the second center electrode part is equal to or greater than 50 μm to less than or equal to 200 μm.

7. The plasma display panel as claimed in claim 5, wherein at least one of the upper connection electrode part, the lower connection electrode part, the first center connection electrode part and the second center connection electrode part comprises one or more connection electrodes.

8. The plasma display panel as claimed in claim 1, wherein the width of at least one of the upper main electrode, the lower main electrode, the first center main electrode and the second center main electrode is equal to or greater than 30 μm to less than or equal to 60 μm.

9. A plasma display apparatus, comprising:
a discharge cell partitioned by barrier ribs;
an upper electrode part comprising a plurality of upper main electrodes and an upper connection electrode part that connects each of the plurality of upper main electrodes, and formed on an upper region of the discharge cell;
a lower electrode part comprising a plurality of lower main electrodes and a lower connection electrode part that connects each of the plurality of lower main electrodes, and formed on a lower region of the discharge cell;
a first center electrode part comprising a plurality of first center main electrodes and a first center connection electrode part that connects each of the plurality of first center main electrodes, and formed between the upper electrode part and the lower electrode part;
a second center electrode part comprising a plurality of second center main electrodes and a second center connection electrode part that connects each of the plurality of second center main electrodes, and formed between the first center electrode part and the lower electrode part;
a first driver that applies first driving pulses to the upper electrode part and the lower electrode part; and
a second driver that applies second driving pulses to the first center electrode part and the second center electrode part.

10. The plasma display apparatus as claimed in claim 9, wherein the first driver applies the first driving pulses to the upper electrode part and the lower electrode part so that the upper electrode part and the lower electrode part function as a scan electrode, and the second driver applies the second driving pulses to the first center electrode part and the second center electrode part so that the first center electrode part and the second center electrode part function as a sustain electrode.

11. The plasma display apparatus as claimed in claim 9, wherein the first driver applies the first driving pulses to the upper electrode part and the lower electrode part so that the upper electrode part and the lower electrode part function as a sustain electrode, and the second driver applies the second driving pulses to the first center electrode part and the second center electrode part so that the first center electrode part and the second center electrode part function as a acan electrode.

12. The plasma display apparatus as claimed in claim 9, wherein the first center electrode part and the second center electrode part are separated from each other.

13. The plasma display apparatus as claimed in claim 9, wherein a gap between the first center electrode part and the second center electrode part is equal to or greater than 50 μm to less than or equal to 200 μm.
